(19) United States
(12) Patent Application Publication
(10) Pub. No.: US 2016/0231163 A1
(43) Pub. Date: Aug. 11, 2016

(54) Device and Method for Measuring a Volume of a Liquid and Method and Device for Calibrating a Liquid Dispensing System

(71) Applicant: MICRONIT MICROFLUIDICS B.V., Enschede (NL)

(72) Inventors: Ronny Van 't Oever, Epse (NL); Marko Theodoor Blom, Delden (NL); Adriaan Johannes Nutma, Hengelo (NL); Herman Jacobus Blok, Retie (BE)

(21) Appl. No.: 15/029,847

(22) PCT Filed: Dec. 24, 2014
(86) PCT No.: PCT/NL2014/050905

§ 371 Date: Apr. 15, 2016

(30) Foreign Application Priority Data
Dec. 24, 2013 (NL) 2012023

(51) Int. Cl. G01F 25/00; G01F 13/00

(52) U.S. Cl. CPC G01F 25/0007; G01F 13/00

(57) ABSTRACT

The invention relates to a device for measuring a volume of a liquid, said device comprising:—a receptacle for receiving said liquid, said receptacle comprising an inlet opening and an outlet opening, and—a capillary channel having capillary action, which capillary channel has a predetermined internal transverse cross-section, wherein an inlet opening of the capillary channel at an first end thereof is in liquid through flow connection with the outlet opening of the receptacle and wherein the other, second end of the capillary channel comprises an opening; wherein:—the inlet opening of the receptacle has a larger transverse cross-section than the inlet opening of said capillary channel, and—a length of a liquid slug in the capillary channel is a measure for said volume. The invention further relates to a method for measuring a volume of a liquid using such a device, a method for calibrating a liquid dispensing system using such a device, a calibrating system for calibrating a liquid dispensing system using such a device and a support for supporting a plurality of such devices.

The invention relates to a device and method for measuring a volume of a liquid.

Devices for measuring a volume of a liquid are generally known. An example of such a device is a measuring cup. A disadvantage of a such measuring cup is that it is not suitable for measuring small volumes of liquid, in particular volumes in the range of 1 to 200 μl more particular volumes in the range of 1-100 nl.

It is an object of the invention to overcome the above described disadvantage. In particular it is an object of the invention to provide a device according to the preamble that is suitable for measuring small volumes of liquid. More particularly, it is an object of the invention to provide a device according to the preamble that is suitable for measuring small volumes of liquid accurately and/or precisely and/or quickly and/or easy.

This object is achieved by a device according to the preamble that in accordance with the invention comprises:

a receptacle for receiving said liquid, said receptacle comprising an inlet opening and an outlet opening, and

a capillary channel having capillary action, which capillary channel has a predetermined internal transverse cross-section, wherein an inlet opening of the capillary channel at an first end thereof is in liquid through flow connection with the outlet opening of the receptacle and wherein the other, second end of the capillary channel comprises an opening;

wherein:

the inlet opening of the receptacle has a larger transverse cross-section than the inlet opening of said capillary channel, and

a length of a liquid slug in the capillary channel is a measure for said volume.

The liquid to be measured is introduced into the receptacle via an inlet opening thereof, wherein an outlet opening of the receptacle provides a liquid through flow connection with a first end of the capillary channel. The inlet opening of the receptacle has a larger transverse cross-section than said capillary channel, which provides easy introduction of said liquid in said receptacle. Liquid introduction into the receptacle may be contactless, e.g., by using Drop-on-Demand jetting technology, or by means of injection where a contact is established between the dispenser and the receptacle, and the mode of injection may be through air-displacement or through positive displacement action. Transport of the liquid from the receptacle into the capillary channel occurs by a pressure difference between a front and back meniscus of a liquid slug, in particular by means of capillary action. Additionally, a transient pressure build-up as a result of injection may facilitate the flow of liquid into the capillary channel. The opening at the other, second end of the channel provides an outlet for displaced air in the channel. The liquid will stop in the channel as soon as the pressure drop over the front and back meniscus of the liquid slug as seen in the transport direction of the liquid in the capillary channel is balanced. Because the capillary channel has a predetermined internal transverse cross-section the length of the liquid slug in the channel is then a measure for said volume.

With this device according to the invention the volume of the liquid may be measured accurately and/or precisely and/or quickly and/or easily also for small quantities of liquid.

Small quantities may in particularly be accurately and/or precisely and/or quickly and/or easily measured because of the small dimensions of a capillary channel with capillary action. Because of the small dimensions, in particular the small cross sectional area of such a capillary channel with capillary action, any variation of volume in liquid results in a relatively large variation in length of the liquid slug.

It is noted here that measuring a volume is to be understood throughout this patent application as measuring a quantitative volume or as measuring a deviation from a predetermined volume. In particular, measuring a volume is to be understood throughout this patent application as measuring the quantitative volume of any unknown volume or the deviation of said any unknown volume from a predetermined volume. Measuring is thus not to be understood as metering wherein the supply of a liquid is stopped once a predetermined volume has been reached.

It is further noted that the transverse cross-section of said capillary channel may have any desired shape, such as, but not limited thereto, square, rectangular, circular, elliptic.

It is further noted that the device according to the invention is in particular an autonomous capillary system for measuring a volume of a liquid, in particular for measuring micro or nano volumes. In such an autonomous system no (external) pump is required.

The length of the capillary channel may be chosen in accordance with the predetermined transverse cross-section thereof and in accordance with the maximum volume to be measured, wherein the length is chosen somewhat larger to guarantee that said volume may be measured, even if it deviates from, and especially exceeds an expected volume. For example, said determined cross-section may be chosen between 100 μm2 and 1 mm2, preferably approximately 1000 μm2, and said length may be chosen between 1-12 cm, preferably 4 cm.

Preferably, the capillary pressure of, in particular in, the capillary channel at each position within the channel is larger than the capillary pressure of, in particular in, the receptacle in an area adjacent to said outlet opening to allow for capillary action to occur.

As a result of this capillary action the capillary channel will suck out all liquid of said receptacle into said capillary channel, such that the length of the liquid slug in the channel is an accurate measure for said volume. Said capillary pressure of the channel and of the receptacle is determined by various parameters, such as the effective radius of the channel and the receptacle and the contact angle with the liquid in the channel and the receptacle. For a given liquid, the contact angle with the channel and the receptacle is determined by the material of the channel and the receptacle. Said material may be the material from which the channel and the receptacle is made, or may be a layer or coating provided thereon. In practice, the material of the channel differs from the material of the receptacle, such that the capillary pressure of the channel differs from, and is in particular larger than, the capillary pressure of the receptacle. The material of the channel and/or the receptacle may be adapted to the type of liquid to be measured with said device.

In an embodiment of the device according to the invention, said device comprises a capillary stop valve at or near the first end or at or near the second end of the capillary channel.

Said capillary stop valve will stop the transport of the liquid slug in the capillary channel at an accurately known location, such that said length of said liquid slug may be easily and/or accurately be determined Said capillary stop valve may either be located at or near the first end of the capillary channel, such that said transport of the liquid slug will stop as soon as the liquid is transported out of the receptacle, or at or near the second end of the capillary channel, such that the liquid slug will stop there. In either case, the volume of the channel is chosen in such a way that this is always larger than the volume to be measured. Because of this, the unknown volume will always be received and stopped, both fully autonomously, by the combined action of capillary flow, followed by flow stoppage by the capillary stop valve at a known location. In this way, volume measurement can be performed fully autonomously, independent of any user action after insertion of the unknown volume of liquid.

Said capillary stop valve may be provided by any mechanism of the group comprising: a change in geometry of said capillary channel or said receptacle, electro-wetting, topographical surface morphology, temperature differences along the capillary channel seen in a longitudinal direction, surface tension differences at the locations of a head and tail of the liquid slug, surface energy differences between the surfaces of the capillary channel at the locations of the head and tail of the liquid slug, or any combination thereof.

The transport of the liquid slug in the capillary channel will stop when there is such a local change in capillary pressure, that the pressure difference between the front and back meniscus as seen in the transport direction of the liquid in the capillary channel is balanced. Any of the above described mechanisms or any combination thereof may provide said local change in capillary pressure. Said type of mechanism or said combination of mechanisms may for example be chosen in accordance with a liquid to be measured.

Said receptacle may have either a hydrophobic or a hydrophilic surface at least in an area adjacent to said outlet opening.

Said receptacle may be made of a hydrophobic or a hydrophilic material, or may comprise a layer or coating of such a material arranged at the inner surface of the receptacle. The choice to provide a hydrophobic or hydrophilic surface may depend on the type of liquid.

Said receptacle may have a shape such that it is adapted to a shape of a liquid dispenser or injector for dispensing or injecting said liquid in said receptacle.

Practically said capillary channel comprises a visible scale for reading out said length of the liquid slug.

Said scale may either provide a quantitative volume of said liquid or may show a deviation from a predetermined volume of said liquid, in accordance with the invention and the interpretation of measuring a volume as noted above. Said scale may for example be applied by (laser) marking or scribing the surface of the capillary channel or a support supporting said capillary channel.

Additionally or alternatively said capillary channel may comprise a plurality of sensors for sensing the position of at least one meniscus of the liquid slug.

In an embodiment of the device according to the invention said channel has a first part and a second part, wherein the capillary pressure of, in particular in, the first part is larger than the capillary pressure of, in particular in, the second part.

In such an embodiment the capillary action of the first part is larger than the capillary action of the second part. If the first part is in liquid through connection with the receptacle and the second part is located downstream thereof as seen in the transport direction of said liquid slug, the stop valve will be located at the inlet opening of the channel, in particular at the inlet opening of the first part of the channel. If the second part is in liquid through connection with the receptacle and the first part is located downstream thereof as seen in the transport direction of said liquid slug, the liquid slug will be transported out of the second part until the front meniscus reaches the stop valve at or near the second end of the channel.

As described above, the capillary pressure of the first part and the second part of the channel is determined by the effective radius thereof and a contact angle with the liquid inside the channel. For providing a difference in capillary pressure between the two parts it is possible to provide a difference in the effective radii thereof and/or a difference in the contact angle of the liquid inside the two parts. A difference between the effective radius of both parts may be provided by the two parts having different dimensions and/or geometries. A difference between the contact angle with the liquid inside the two parts may be provided by each part having a different material on the inner surface of the parts. This may be obtained by two parts that are made of a different material, or by two parts that have a different layer or coating provided on the inner surface thereof.

The invention further relates to a method for measuring a volume of a liquid, comprising the steps of:

(a) providing the device according to any of the claims 1-9;

(b) dispensing or injecting a volume of liquid in said receptacle;

(c) measuring the volume dispensed or injected in step (b) by reading or sensing a length of a liquid slug in the capillary channel.

Such a method offers the advantages of measuring small volumes of liquid accurately and/or precisely and/or quickly and/or easy, as described above.

Step (b) is in particular performed by dispensing or injecting an unknown volume of liquid in said receptacle, which unknown volume is measured in step (c) by reading or sensing said length.

The invention further relates to a method for calibrating a liquid dispensing system, comprising the steps of:

(d) providing the device according to any of the claims 1-9;

(e) dispensing or injecting a volume of liquid in said receptacle by said liquid dispensing system;

(f) measuring the volume dispensed or injected in step (e) by reading or sensing a length of a liquid slug in the capillary channel, and

(g) maintaining or adjusting the amount of liquid dispensed by said liquid dispensing system in accordance with said measured volume.

Said method may be performed automatically or by a person. The method offers the advantage of calibrating a liquid dispensing system accurately and/or precisely and/or quickly and/or easy.

Step (e) is in particular performed by dispensing or injecting an unknown volume of liquid in said receptacle, which unknown volume is measured in step (f) by reading or sensing said length.

Step (g) is in particular performed by comparing said measured volume with a predetermined volume, and by maintaining or adjusting the amount of liquid dispensed such that said dispensed or injected volume will be equal to said predetermined volume.

The invention further relates to a calibrating system for calibrating a liquid dispensing system, said calibrating system comprising:

a device according to claim 7 or 8;

optionally, a means for automatically reading or sensing said measured volume, and

a controller for controlling the amount of liquid dispensed by said liquid dispensing system in accordance with said read of sensed volume.

Said device may work automatically or may be controlled by a person. If the device works automatically it comprises a means for automatically reading or sensing said measured volume, wherein said controller controls the amount of liquid dispensed by said liquid dispensing system based on input from said means. If the device is operated or controlled by a person said person may determine said volume by reading or sensing said volume, wherein said person provides input to said controller for controlling the amount of liquid dispensed by said liquid dispensing system. The device offers the advantage of calibrating a liquid dispensing system accurately and/or precisely and/or quickly and/or easy.

The invention further relates to a support for supporting a plurality of said devices according to any of the claims 1-9.

The devices are preferably arranged on the support in such a manner that the receptacles thereof are arranged in accordance with the well-to-well pitch in a so called SBS micro plate format, and also the width of the support is preferably compliant with the SBS micro plate format. In a liquid dispensing system the liquid is dispensed in the wells of the SBS micro plate. By adjusting the dimensions and the locations of the receptacles such that they are in accordance with the wells of the SBS micro plate, calibration of the liquid dispensing system may take place automatically. A row of 8, 16, 12, or 24 of said devices can be accommodated within the above mentioned format.

The invention will be further elucidated with reference to figures shown in a drawing, in which:

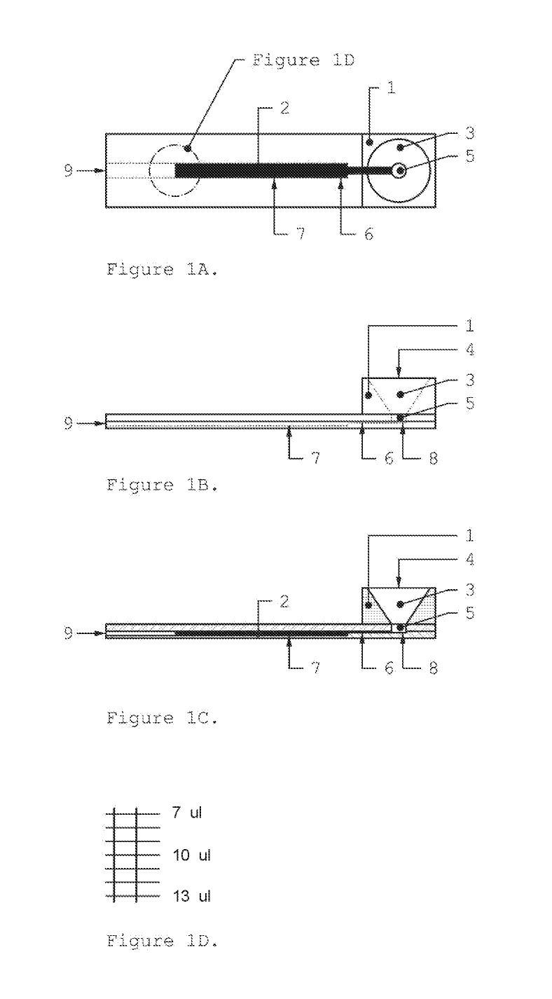

FIGS. 1A-1D schematically show a device according to a first embodiment of the invention, wherein FIG. 1A is a top view, FIG. 1B is a side view, FIG. 1C is a longitudinal cross-section and FIG. 1D is a detail from FIG. 1A;

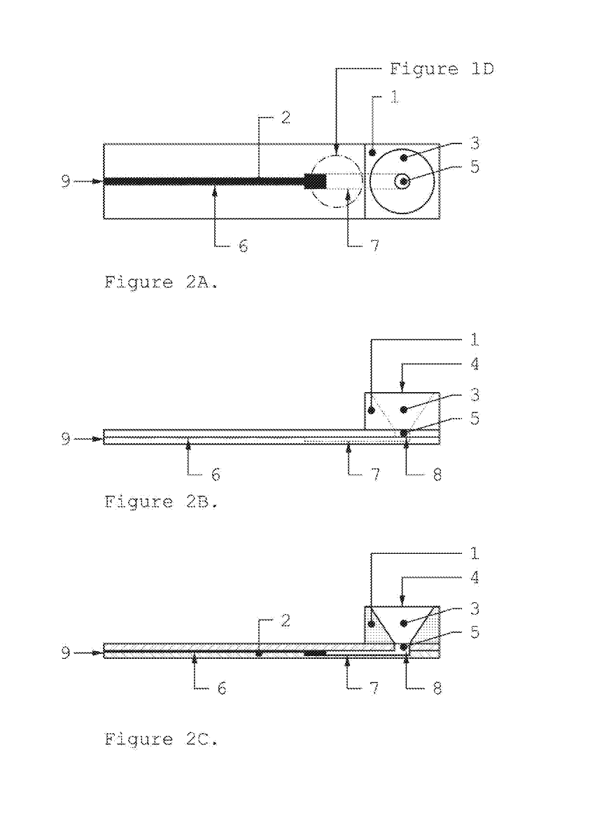

FIGS. 2A-2C schematically show a device according to a second embodiment of the invention, wherein FIG. 2A is a top view, FIG. 2B is a side view, FIG. 2C is a longitudinal cross-section; and

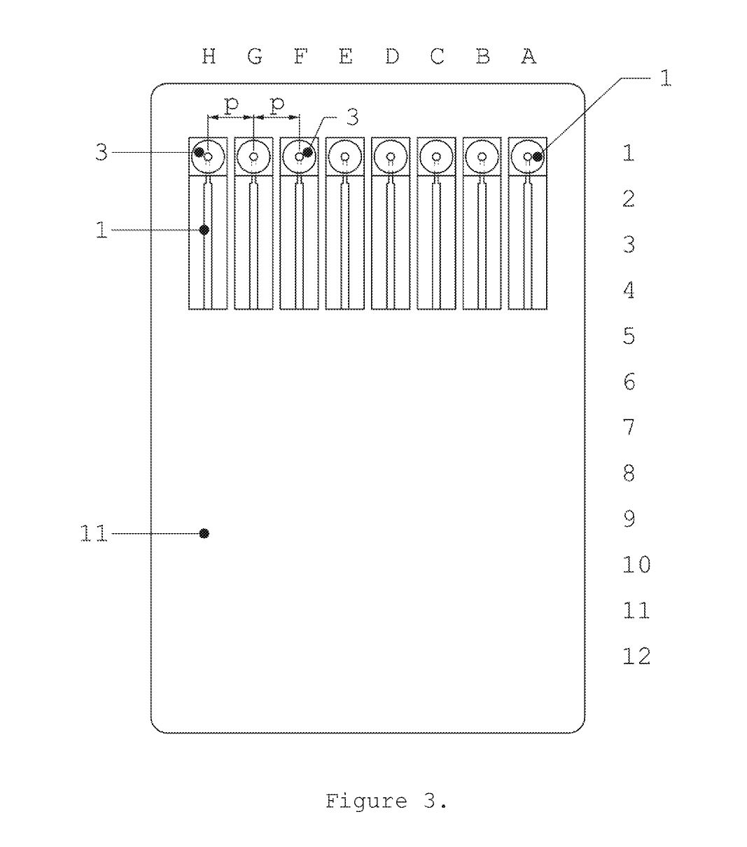

FIG. 3 schematically shows a top view of a support for a plurality of devices according to the invention.

In the figures similar elements are denoted by similar reference numerals.

FIGS. 1A-1D show a first embodiment of a device 1 for measuring a volume of a liquid 2. Said device 1 comprises a receptacle 3 for receiving said liquid, which receptacle comprises an inlet opening 4 and an outlet opening 5. The receptacle 3 tapers from the inlet opening 4 to the outlet opening 5, such that the inlet opening 4 has a larger transverse cross-section than the outlet opening 5. This makes dispensing or injecting liquid in the receptacle 3 relatively easy. In addition thereto, said tapering shape may guide a tip of a dispensing system. The device 1 further comprises a capillary channel having capillary action, which capillary channel has a first part 6 with relatively large capillary pressure and a second part 7 with relatively small capillary pressure, but wherein both capillary pressures are larger than the capillary pressure of the receptacle 3. In this example, the difference in capillary pressure between the first part 6 and the second part 7 is provided by a difference in the effective radii thereof, because the first part 6 has a relatively small effective radius and the second part 7 has a relatively large effective radius. The difference in capillary pressure between the channel and the receptacle 3 is provided by a combination of effective radii, wherein the effective radii of both the first part 6 and the second part 7 are smaller than the effective radius of the receptacle 3, and a difference in a contact angle with the liquid dispensed in the device, because the receptacle 3 is practically made from a different material than the channel. The first part 6 has an inlet opening 8 at an first end thereof, which inlet opening 8 is in liquid through flow connection with the outlet opening 5 of the receptacle 3. As a result of the relatively large capillary pressure of first part 6 and second part 7, which are larger than the capillary pressure of the receptacle 3, the channel will suck out all liquid from the receptacle 3 into the channel by means of capillary action. The transport of the liquid slug in the channel will stop as soon as the pressure drop over the front and back meniscus thereof as seen in the transport direction of the liquid in the capillary channel is balanced, i.e. when the back meniscus is at the transition location between the outlet opening 5 of the receptacle and the inlet opening 8 of the channel, because of the sudden change in geometry there between. Optionally other mechanisms for balancing the pressure may be provided. At the other end of the channel it may comprise an opening for letting out displaced air. The channel has a predetermined internal transverse cross-section, such that the length of the liquid slug in the capillary channel is a measure for said volume. As is shown in FIGS. 1A and 1D, a visible scale is provided in the area of the second part 7 of the channel. The scale indicates the quantitative volume of the liquid, in this case between 7 and 13 μl. Instead, said scale may indicate a deviation from 10 μl, wherein 10 μl is indicated by 0 μl, 7 μl is indicated by −3 μl and 13 μl is indicated by 3 μl. Said scale may be read by a person or by visual detection means, such as a camera or the like.

The scale may be adjusted to the volume of liquid to be measured with said device. The internal transverse cross-section and/or the length of the channel may also be adjusted in accordance therewith.

FIGS. 2A-2C show a second embodiment of a device 1 for measuring a volume of a liquid 2. Said device 1 comprises a receptacle 3 for receiving said liquid, which receptacle comprises an inlet opening 4 and an outlet opening 5. The receptacle 3 tapers from the inlet opening 4 to the outlet opening 5, such that the inlet opening 4 has a larger transverse cross-section than the outlet opening 5. This makes dispensing or injecting liquid in the receptacle 3 relatively easy. The device 1 further comprises a capillary channel having capillary action, which capillary channel has a first part 6 with relatively large capillary pressure and a second part 7 with relatively small capillary pressure, but wherein both capillary pressures are larger than the capillary pressure of the receptacle 3. The second part 7 has an inlet opening 8 at an first end thereof, which inlet opening 8 is in liquid through flow connection with the outlet opening 5 of the receptacle 3. Because the capillary pressure of second part 7 is larger than the capillary pressure of the receptacle 3, the channel will suck out all liquid from the receptacle 3 into the channel by means of capillary action. Because the capillary pressure of the first part 6 is larger than the capillary pressure of the second part 7 and of the capillary pressure of the receptacle, and thereby the capillary action of the first part 6 is larger than the capillary action of the second part 7, the liquid slug will not stop at the transition point between the outlet opening 5 of the receptacle 3 and the inlet opening 8 of the channel, but will continue until the front meniscus is at the second end of the channel where the channel comprises an outlet opening 9 for letting out displaced air, because of the sudden change in geometry there between. Optionally other mechanisms for balancing the pressure may be provided. Also in this embodiment the channel has a predetermined internal transverse cross-section, such that the length of the liquid slug in the capillary channel is a measure for said volume. The visible scale, which may be similar to the scale shown in FIG. 1D, is again arranged in the area of the second part 7 of the channel, as indicated by reference numeral 10.

It is noted that instead of a visible scale as shown in FIG. 1D a plurality of sensors for sensing the position of at least one meniscus of the liquid slug may be provided. Such sensors may provide an electrical signal when they are in contact with the liquid. The location of the sensors that do provide an electrical signal is then an indication for the location of the liquid slug, in particular the location of the meniscus or menisci thereof, which will be a measure for the length of the liquid slug.

FIG. 3 shows a support 11 with in total eight devices 1 according to the invention. The devices 1 are arranged on the support 11 in such a manner that the receptacles 3 thereof are arranged in accordance with the well-to-well pitch p in a so called SBS micro plate format, and also the width of the support is preferably compliant with the SBS micro plate format. Instead of eight devices 1, less or more devices 1 may be provided on the support.

It is noted that the invention is not limited to the shown embodiments but also extends to variants within the scope of the appended claims.

For example, instead of a capillary channel having a part with relatively large capillary pressure and a part with relatively small capillary pressure, said channel may have one part with a uniform capillary pressure over the whole length thereof.

For example, the scale shown in FIG. 1D may be adapted to the volume of liquid to be measured by a particular device. As explained before, the device according to the invention is in particular suitable for measuring relatively small volumes of liquid, in particular between 1 to 200 more particular between 1-100 nl.

1. A device for measuring a volume of a liquid, said device comprising:
a receptacle for receiving said liquid, said receptacle comprising an inlet opening and an outlet opening, and
a capillary channel having capillary action, which capillary channel has a predetermined internal transverse cross-section, wherein an inlet opening of the capillary channel at an first end thereof is in liquid through flow connection with the outlet opening of the receptacle and wherein the other, second end of the capillary channel comprises an opening;
wherein:
the inlet opening of the receptacle has a larger transverse cross-section than the inlet opening of said capillary channel, and
a length of a liquid slug in the capillary channel is a measure for said volume.

2. The device according to claim 1, wherein the capillary pressure of the capillary channel at each position within the channel is larger than the capillary pressure of the receptacle in an area adjacent to said outlet opening to allow for capillary action to occur.

3. The device according to claim 1, comprising a capillary stop valve at or near the first end or at or near the second end of the capillary channel.

4. The device according to claim 3, wherein said stop valve is provided by any mechanism of the group comprising: a change in geometry of said capillary channel or said receptacle, electro-wetting, topographical surface morphology, temperature differences along the capillary channel seen in a longitudinal direction, surface tension differences at the locations of a head and tail of the liquid slug, surface energy differences between the surfaces of the capillary channel at the locations of the head and tail of the liquid slug, or any combination thereof.

5. The device according to claim 1, wherein said receptacle has a hydrophobic or hydrophilic surface at least in an area adjacent to said outlet opening.

6. The device according to claim 1, wherein said receptacle has a shape such that it is adapted to a shape of a liquid dispenser or injector for dispensing or injecting said liquid in said receptacle.

7. The device according to claim 1, wherein said capillary channel comprises a visible scale for reading out said length of the liquid slug.

8. The device according to claim 1, wherein said capillary channel comprises a plurality of sensors for sensing the position of at least one meniscus of the liquid slug.

9. The device according to claim 1, wherein said channel has a first part and a second part, and wherein the capillary pressure of the first part is larger than the capillary pressure of the second part.

10. Method A method for measuring a volume of a liquid, comprising the steps of: (a) providing the device according to claim 1;
(b) dispensing or injecting a volume of liquid in said receptacle;
(c) measuring the volume dispensed or injected in step (b) by reading or sensing a length of a liquid slug in the capillary channel.

11. A method for calibrating a liquid dispensing system, comprising the steps of:
(d) providing the device according to claim 1;
(e) dispensing or injecting a volume of liquid in said receptacle by said liquid dispensing system;
(f) measuring the volume dispensed or injected in step (e) by reading or sensing a length of a liquid slug in the capillary channel, and
(g) maintaining or adjusting the amount of liquid dispensed by said liquid dispensing system in accordance with said measured volume.

12. Calibrating system for calibrating a liquid dispensing system, said calibrating system comprising:
a device according to claim 7;
optionally, a means for automatically reading or sensing said measured volume, and
a controller for controlling the amount of liquid dispensed by said liquid dispensing system in accordance with said read of sensed volume.

13. A support for supporting a plurality of said devices according to claim 1.
